(19) United States
(12) Patent Application Publication
(10) Pub. No.: US 2008/0016460 A1
(43) Pub. Date: Jan. 17, 2008

(54) Data processing apparatus and method using soft keyboard

(75) Inventor: In-cheon Park, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd

(21) Appl. No.: 11/703,730

(22) Filed: Feb. 8, 2007

(30) Foreign Application Priority Data
Jul. 13, 2006 (KR) 2006-65642

(51) Int. Cl. G06F 3/048

(52) U.S. Cl. 715/783; 715/790

(57) ABSTRACT

A data processing apparatus and method using a soft keyboard. A touch screen unit includes a first window on which a soft keyboard to input characters by a touch screen mode is displayed, and a second window on which the characters inputted through the soft keyboard are displayed. When the inputted characters exceed a set width of the second window, a control unit displays a button to request whole screen display of the inputted characters. Accordingly, long sentence data inputted by the touch screen mode are selectively displayed on one screen, so that a user can easily select and edit the data.

### CROSS-REFERENCE TO RELATED APPLICATIONS

This application claims priority under 35 U.S.C. §119(a) of Korean Patent Application No. 2006-65642, filed on Jul. 13, 2006, in the Korean Intellectual Property Office, the entire disclosure of which is hereby incorporated by reference.

### BACKGROUND OF THE INVENTION

1. Field of the Invention

The present general inventive concept relates to a data processing apparatus and method using a soft keyboard, and more particularly, to a data processing apparatus and method using a soft keyboard which enable a user to select and edit data by selectively displaying long sentence data input by a touch screen mode on one screen.

2. Description of the Related Art

A touch screen replacing an input device such as a keyboard or a mouse displays a plurality of images, a text or a soft keyboard on a screen of a display apparatus. A user requests a desired operation by touching the images, text or soft keyboard displayed on the screen of the display apparatus.

The soft keyboard is an image keyboard having the same consonant, vowel and alphabet arrangements as those of a general keyboard. The user can rapidly and precisely input data using the soft keyboard.

FIG. 1 illustrates an operation of editing data by using a soft keyboard provided on a general touch screen.

Referring to FIG. 1, a user inputs desired data by touching an input unit 1 of the soft keyboard displayed on a display apparatus (not illustrated). The input data are displayed on a display unit 3 of the soft keyboard in an order in which the data are input. Since a displayable range of the display unit 3 is limited, part of the data input by the user may not be displayed on the display unit 3. That is, in a case that the input data exceed the displayable range of the display unit 3, previously-input data are not displayed on the display unit 3 and succeeding data are displayed thereon.

After the excessive data input, the user may desire to review or correct the previously-input data, namely, the data which are not displayed on the display unit 3. Since all of the data are not displayed on the display unit 3, the user must move a cursor 7 to a left side by using a direction key 5 in order to review or correct the data which are not displayed on the display unit 3. The user reviews all of the input data by continuously operating the direction key 5.

However, the direction key 5 moves the cursor 7 to the left side of the display unit 3 by one character at a time. If the user has to review a large amount of data, it takes a long time to review and edit the data. Furthermore, the user must touch the direction key 5 every time to move the cursor 7, which causes discomfort and inconvenience. As a result, the user may carelessly review the data, and store mistakenly-edited data, or transmit such data to a correspondent apparatus.

In addition, when the user reviews the data as described above, the display unit 3 displays only one row of data at a time. It is thus inconvenient to move the cursor 7 to target data to be edited.

### SUMMARY OF THE INVENTION

The present general inventive concept provides a data processing apparatus and method using a soft keyboard which enables a user to easily select and edit data by selectively displaying long sentence data input by a touch screen mode on one screen.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a data processing apparatus using a soft keyboard, including a touch screen unit to display a first window on which a soft keyboard to input characters by a touch screen mode is displayed, and a second window on which the characters input through the soft keyboard are displayed, and a control unit to control the touch screen unit to display a button to request whole screen display of the input characters, when the input characters exceed a set width of the second window.

The data processing apparatus may further include a storing unit to store widths of the characters displayed on the soft keyboard and the width of the second window.

When the width of the second window is smaller than a total width of the characters displayed on the second window, the control unit may control the touch screen unit to display the button to request the whole screen display.

When the button to request the whole screen display is selected, a third window to display all of the input characters may be displayed. The third window may be displayed to overlap on the soft keyboard.

When the character displayed on the third window is selected, the selected character may be displayed on the second window. After at least one character which needs to be edited is selected, the control unit may remove the third window from display.

The character may be selected for deletion or revision.

The foregoing and/or other aspects and utilities of the present general inventive concept may also be achieved by providing a data processing method using a soft keyboard, the method including) displaying a soft keyboard to input characters by a touch screen mode on a first window of a screen, displaying the characters input through the soft keyboard on a second window of the screen, and when the input characters exceed the set width of the second window, displaying a button to request whole screen display of the input characters.

The widths of the characters displayed on the soft keyboard and the width of the second window may be stored in a memory in advance.

The button may be displayed when the width of the second window is smaller than the total width of the characters displayed on the second window.

The data processing method may further include when the displayed button is selected, displaying a third window to display all of the input characters.

The third window may be displayed to overlap on the soft keyboard.

The data processing method may further include when the character displayed on the third window is selected, displaying the selected character on the second window.

After the character is selected in step (e), the third window may be removed from display.

The character may be selected for deletion or revision.

The foregoing and/or other aspects and utilities of the present general inventive concept may also be achieved by providing a data processing apparatus including a user interface to display a first window on which a soft keyboard which inputs characters by touch and a second window on which the characters input through the soft keyboard are displayed, and a control unit to control the user interface to selectively display a third window based on the number of characters input through the soft keyboard.

The foregoing and/or other aspects and utilities of the present general inventive concept may also be achieved by providing a computer-readable medium having embodied thereon a computer program to execute a data processing method using a soft keyboard, the method including displaying a soft keyboard to input characters by a touch screen mode on a first window of a screen, displaying the characters input through the soft keyboard on a second window of the screen, and when the input characters exceed a set width of the second window, displaying a button to request whole screen display of the input characters.

The foregoing and/or other aspects and utilities of the present general inventive concept may also be achieved by providing a method of displaying data on a user interface, the method including displaying a first window on which a soft keyboard to input characters by touch are displayed, displaying a second window on which the characters input through the soft keyboard are displayed, and controlling the user interface to selectively display the characters input through the soft keyboard in a third window overlapping the second window.

The foregoing and/or other aspects and utilities of the present general inventive concept may also be achieved by providing a computer-readable recording medium having embodied thereon a computer program to execute a method of displaying data on a user interface, the method including displaying a first window on which a soft keyboard to input characters by touch are displayed, displaying a second window on which the characters input through the soft keyboard are displayed, and controlling the user interface to selectively display the characters input through the soft keyboard in a third window overlapping the second window.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates an operation of editing data by using a soft keyboard provided on a conventional touch screen;

FIG. 2 illustrates a schematic block diagram of a data processing apparatus using a soft keyboard in accordance with an embodiment of the present general inventive concept;

FIGS. 3A to 3D are diagrams illustrating examples of a user interface screen including the soft keyboard displayed on a display unit of FIG. 2;

FIG. 4 illustrates a schematic flowchart of a data processing method using the soft keyboard of FIG. 2; and

FIG. 5 illustrates a block diagram of an image forming apparatus using the data processing apparatus of FIG. 2.

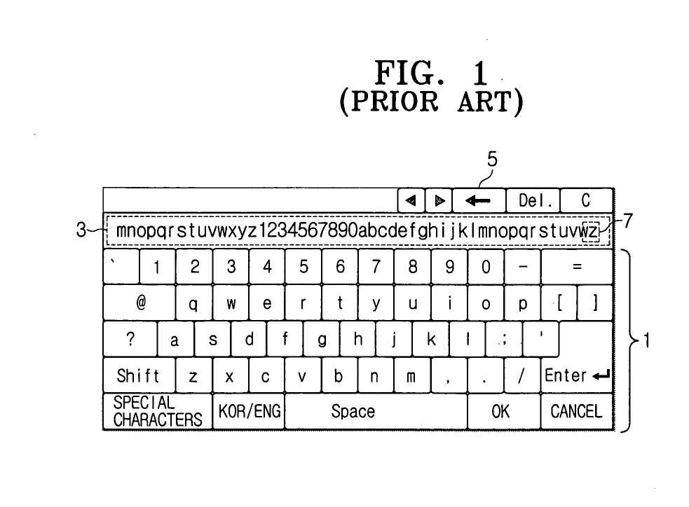

Throughout the drawings, the same drawing reference numerals will be understood to refer to the same elements, features, and structures.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A data processing apparatus and method using a soft keyboard in accordance with various embodiments of the present general inventive concept will now be described in detail with reference to the accompanying drawings.

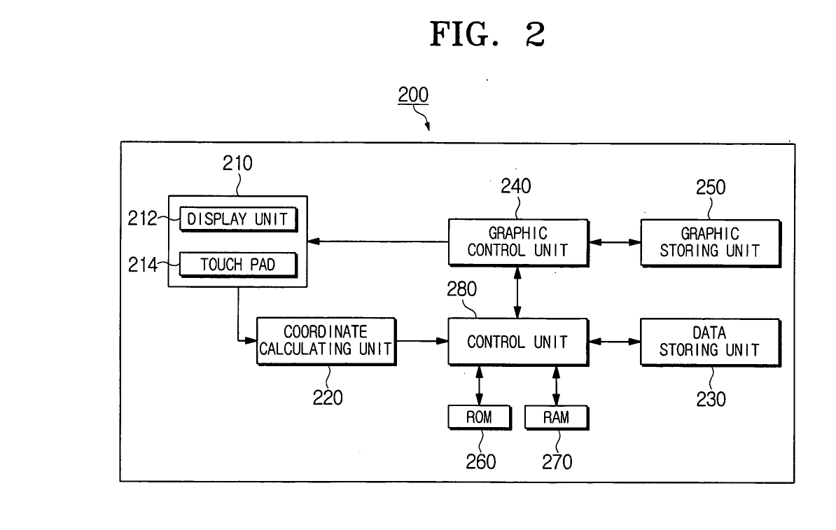

FIG. 2 is a schematic block diagram illustrating the data processing apparatus using the soft keyboard in accordance with an embodiment of the present general inventive concept.

As illustrated in FIG. 2, the data processing apparatus 200 using the soft keyboard includes a touch screen unit 210, a coordinate calculating unit 220, a data storing unit 230, a graphic control unit 240, a graphic storing unit 250, a ROM 260, a RAM 270 and a control unit 280.

The touch screen unit 210 is a user interface through which various functions supported by the data processing apparatus 200 are selected by a touch screen mode. The touch screen unit 210 includes a display unit 212 and a touch pad 214.

The display unit 212 is controlled by the control unit 280, to display an operation processing state of the data processing apparatus 200, and various images, characters, numbers and symbols supporting input of characters, numbers, directions, etc. by a touch screen mode. Generally, a liquid crystal display (LCD) or a cathode ray tube (CRT) is used as the display unit 212. More specifically, the display unit 212 displays soft keyboard buttons to support data input using the soft keyboard.

The touch pad 214 senses a touch of an image displayed on the display unit 212, generates an electrical signal corresponding to the touch-sensed position, and converts the electrical signal into a digital signal. For example, in order to sense a touch signal from a user, the touch pad 214 is made of a specially-treated indium tin oxide (ITO) glass or ITO film.

When the soft keyboard button displayed on the display unit 212 is selected by an external touch, the touch pad 214 generates an electric potential corresponding to the soft keyboard button, and converts the electric potential into a digital signal.

The coordinate calculating unit 220 calculates coordinates corresponding to a touch input on the basis of the digital signal from the touch pad 214.

The data storing unit 230 stores characters, images and symbols necessary for initial display at an initial stage of the display unit 212 when the data processing apparatus 200 is turned on, and also stores coordinates of each character, image and symbol.

Also, the data storing unit 230 stores coordinates, functions corresponding to each coordinate, and data such as characters, images and symbols. Here, one or many characters, images and symbols can be stored in each coordinate. For example, when the coordinates calculated by the coordinate calculating unit 220 represent a function of requesting display of the soft keyboard, the data storing unit 230 stores a plurality of characters, images and symbols necessary to display the soft keyboard.

The data storing unit 230 stores sizes (width×length) of the characters, images and symbols corresponding respectively to the coordinates, and also stores sizes including widths of a first window and a second window displayed on a user interface screen discussed later.

The graphic control unit 240 generates various touch screens by using a program stored in the graphic storing unit 250 under control of the control unit 280. For example, when power is on, the graphic control unit 240 generates the touch screen and the soft keyboard screen displayed on the display unit 212 at the initial stage.

The ROM 260 stores various control programs to execute the functions of the data processing apparatus 200.

The RAM 270 stores various data generated during the operation of the data processing apparatus 200.

The control unit 280 controls all of the operations of the data processing apparatus 200 according to the control programs stored in the ROM 260.

In more detail, when power is on, the control unit 280 reads the data necessary for the initial touch screen and the sizes of the data from the data storing unit 230, outputs the data and sizes to the graphic control unit 240, and controls the graphic control unit 240 and the display unit 212 to generate and display an initial touch screen at the initial stage.

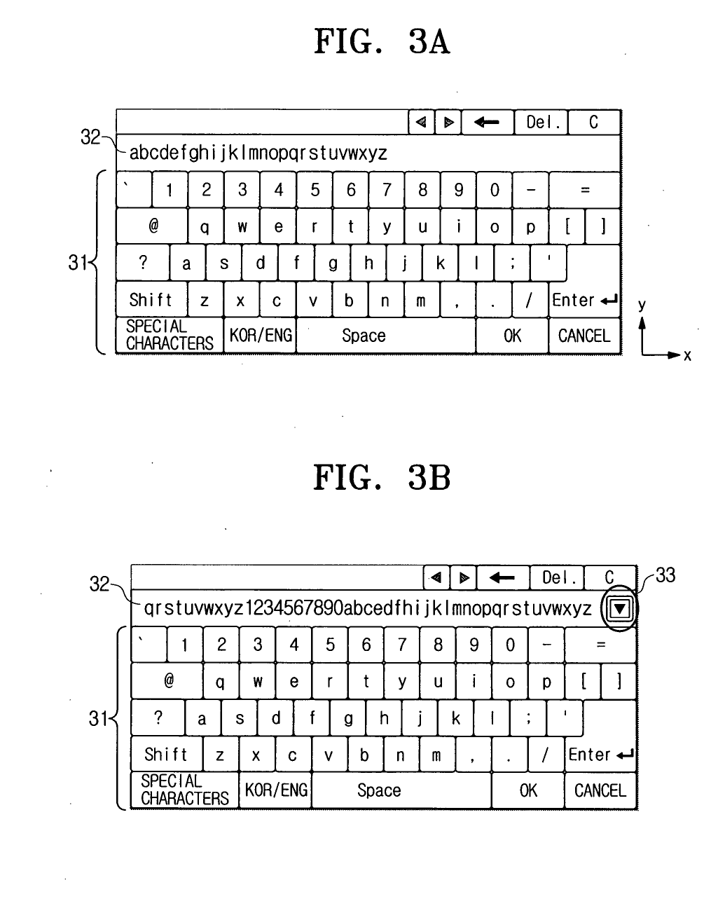

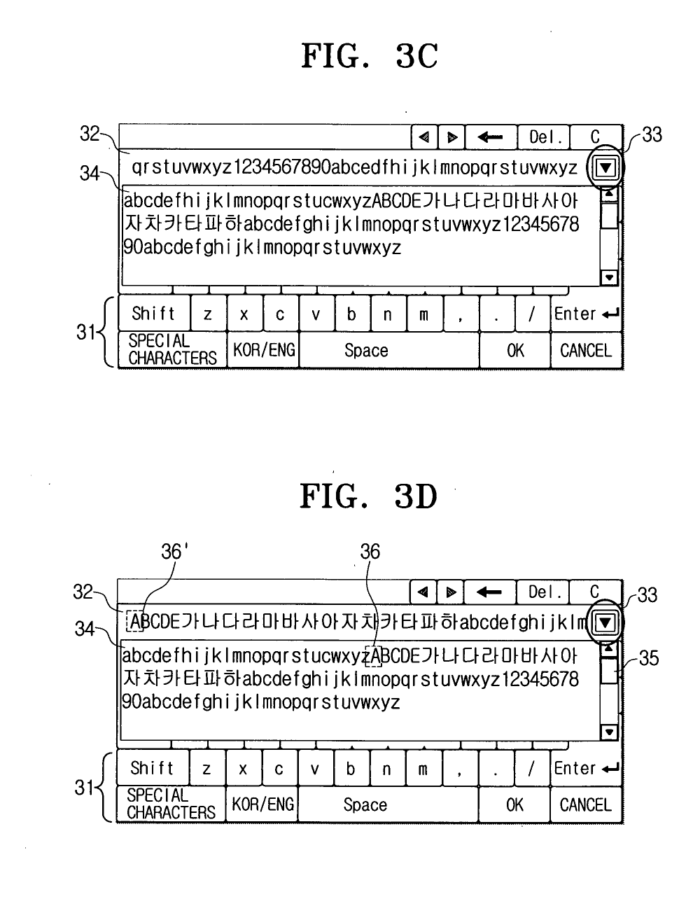

When the soft keyboard button is selected and first coordinates corresponding to the soft keyboard button are output from the coordinate calculating unit 220, the control unit 280 reads the data corresponding to the first coordinates, namely, the plurality of characters, numbers and symbols necessary to display the soft keyboard from the data storing unit 230, and provides the data to the graphic control unit 240. The control unit 280 controls the graphic control unit 240 to generate a user interface screen of FIG. 3A by using the program stored in the graphic storing unit 250.

FIG. 3A is an exemplary diagram illustrating a user interface screen displayed on the display unit of FIG. 2, when a soft keyboard button is selected.

In accordance with an embodiment of the present general inventive concept, as illustrated in FIGS. 2 and 3A, the user interface screen displaying the soft keyboard includes a first window 31 and a second window 32.

The first window 31 displays the soft keyboard to input characters by a touch screen mode. The soft keyboard is displayed on the display unit 212 with a same shape as that of a general keyboard of a computer, to enable the user to input data by finger or digitizer touches. Hereinafter, for convenience of explanation, the characters are exemplified as the data input by the touch screen mode, namely, various images, characters, numbers and symbols. The characters are not intended to be limited to these examples of input data, and could be composed of other objects.

The characters selected by touches of the soft keyboard are displayed on the second window 32 in a selection order. The characters displayed on the second window 32 are stored in the RAM 270 under control of the control unit 280.

Here, the characters selected through the soft keyboard are calculated as coordinates in the coordinate calculating unit 220, respectively. The control unit 280 processes the characters stored to correspond to the coordinates to be displayed on the second window 32 by the graphic control unit 240.

When the characters displayed on the second window 32 exceed the size of the second window 32, the control unit 280 controls the graphic control unit 240 to display a whole screen button (▾) 33 to request whole screen display of the input characters on part of the soft keyboard as illustrated in FIG. 3B.

In more detail, the control unit 280 reads widths of the characters selected by touches of the soft keyboard from the data storing unit 230, and adds the widths of the characters. That is, whenever the characters are selected by touches, the control unit 280 adds the sizes of the selected characters, and compares the added value with the size of the second window 32 stored in the data storing unit 230. Based on the comparison result, when the added value is larger than the size of the second window 32, the control unit 280 controls the graphic control unit 240 and the display unit 212 to generate and display the soft keyboard displaying the whole screen button 33.

Here, the control unit 280 compares a total horizontal size, namely, a total width of the selected characters with the horizontal width of the second window 32. Especially, when all of the characters have a constant width, the control unit 280 can calculate the total width of the selected characters by counting the characters, and decide whether the total width of the characters exceeds the width of the second window 32.

Referring to FIG. 3B, after the soft keyboard including the whole screen button 33 is displayed, if the whole screen button 33 is selected, the coordinate calculating unit 220 calculates coordinates for the whole screen button 33.

Referring to FIG. 3C, when receiving the coordinates corresponding to the selected whole screen button 33, the control unit 280 controls the graphic control unit 240 to regenerate the soft keyboard including a third window 34 which displays all of the input characters.

For example, as illustrated in FIG. 3C, the control unit 280 controls the graphic control unit 240 and the display unit 212 to regenerate and display the soft keyboard on which the third window 34 appears, and can display the third window 34 to overlap the first window 31.

In the soft keyboard of FIG. 3C, the selected characters stored in the RAM 270 are displayed on the third window 34 in a selection order. When the total width of the stored characters exceeds the width of the third window 34, exceeding characters are displayed on succeeding rows. A scroll bar 35 is displayed on the third window 34, so that the user can check all of the input characters by scrolling the scroll bar 35. Here, temporary coordinates of each character displayed on the third window 34 are determined by a size of the third window 34. The control unit 280 calculates temporary coordinates of each character displayed on the third window 34 by comparing the size of the third window 34 with a total size of the characters, and processes the temporary coordinates of each character to be temporarily stored in the RAM 270.

After previously-input characters are displayed on the third window 34, if the user finds a character which needs to be edited, the user selects the character on the third window 34 by a touch.

When the user selects the character which needs to be edited on the third window 34, the touch pad 214 converts a second electrical signal corresponding to the position of the selected character into a second digital signal, and outputs the second digital signal. The coordinate calculating unit 220 calculates second coordinates corresponding to the second digital signal, and outputs the second coordinates to the control unit 280.

The control unit 280 confirms temporary coordinates mapped with the second coordinates among the temporary coordinates temporarily stored in the RAM 270, and decides that the character corresponding to the temporary coordinates has been selected on the third window 34 by the touch of the user.

The control unit 280 controls the graphic control unit 240 and the display unit 212 to display the selected character corresponding to the temporary coordinates and the characters adjacent to the selected character on the second window 32. Here, the control unit 280 controls a number of the characters displayed on the second window 32 on the basis of a width obtained by subtracting a width of the whole screen button 33 from the width of the second window 32, and processes the selected character to be displayed in a designated position of the second window 32, namely, at a beginning or end portion or between the beginning or end portions.

In addition, when one character is touched on the third window 34 or the character corresponding to the temporary coordinates of the touched character is displayed on the second window 32, the control unit 280 controls the graphic control unit 240 not to display the third window 34. This option can be fixed or selected by the user.

FIG. 3D illustrates one example of characters displayed on the second window, when a character which needs to be edited is touched on the third window.

Referring to FIG. 3D, when the character which needs to be edited, for example, ‘A’ 36 is touched on the third window 34, the touch pad 214 outputs a digital signal corresponding to ‘A’ 36, and the coordinate calculating unit 220 calculates coordinates corresponding to ‘A’ 36 from the digital signal corresponding to ‘A’ 36. The control unit 280 confirms temporary coordinates identical to the coordinates corresponding to ‘A’ 36 among the plurality of temporary coordinates temporarily stored in the RAM 270, and controls the graphic control unit 240 to generate a screen displaying ‘A’ 36′ corresponding to the identical temporary coordinates on the second window 32.

As illustrated in FIG. 3D, the character ‘A’ 36 selected on the third window 34 by the touch of the user is displayed at a front or beginning of the second window 32. The characters adjacent to ‘A’ 36 are displayed together. The number of the displayed characters is decided on the basis of a size (i.e., width) of the second window 32.

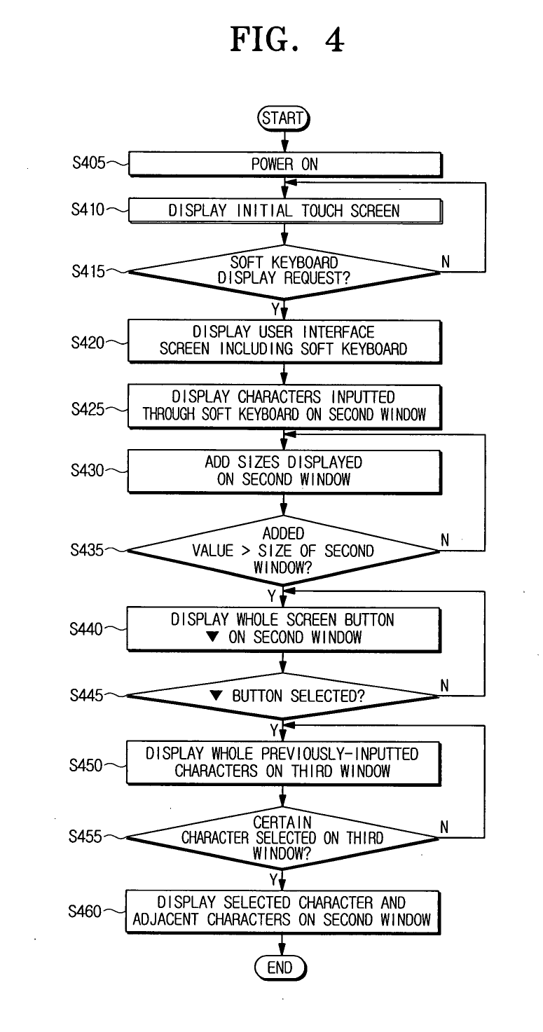

FIG. 4 illustrates a schematic flowchart of the data processing method using the soft keyboard of FIG. 2.

As illustrated in FIGS. 2 to 4, when the data processing apparatus 200 is turned on, the graphic control unit 240 generates the initial touch screen and displays the touch screen on the display unit 212 under control of the control unit 280 (S405 and S410). The initial touch screen includes the soft keyboard button (not illustrated) to request display of the soft keyboard.

When the soft keyboard button to request display of the soft keyboard is selected (operation S415), the control unit 280 controls the graphic control unit 240 and the display unit 212 to generate and display the user interface screen including the soft keyboard as illustrated in FIG. 3A (operation S420).

The user inputs characters by touching the soft keyboard displayed on the first window 31 of the user interface screen, and the control unit 280 controls the graphic control unit 240 and the display unit 212 to display the inputted characters on the second window 32 (operation S425). Here, the control unit 280 extracts characters stored to correspond to the coordinates of the input characters calculated by the coordinate calculating unit 220 from the data storing unit 230, provides the extracted characters to the graphic control unit 240, and also temporarily stores the extracted characters in the RAM 270.

The control unit 280 adds widths of the characters selected in operation S425 and displayed on the second window 32 (operation S430). That is, whenever the characters are selected by touches of the soft keyboard, the control unit 280 reads the widths of the characters from the data storing unit 230 and adds the widths of the characters.

In addition, the control unit 280 compares a value of the added widths with a size of the second window 32 stored in the data storing unit 230. For example, the control unit 280 adds the horizontal axis sizes x, namely, widths of the selected characters. When a total added horizontal length (i.e., width) of the characters is larger than the actual horizontal length, namely, the width of the second window 32 (operation S435), the control unit 280 controls the graphic control unit 240 and the display unit 212 to display the whole screen button 33 on part of the second window 32 as illustrated in FIG. 3B (operation S440).

When the whole screen button 33 is selected by a touch in operation S440 (operation S445), the control unit 280 controls the graphic control unit 240 and the display unit 212 to generate and display a user interface screen on the display unit 212, including the third window 34, as illustrated in FIG. 3C (operation S450). The third window 34 overlaps on the soft keyboard and displays all of the characters input in operation S425.

When one character or a predetermined size block of characters is selected from among the characters displayed on the third window 34 in operation S450 (operation S455), the control unit 280 controls the graphic control unit 240 and the display unit 212 to generate a user interface screen on the display unit 212 to display the selected character or block and adjacent characters on the second window 32 as illustrated in FIG. 3D (operation S460). The method of the control unit 280 extracting the selected character and the adjacent characters from the RAM 270 and displaying the extracted characters on the second window 32 in operation S460 has been described in detail with reference to FIGS. 3A to 3D, and thus detailed explanations thereof are omitted.

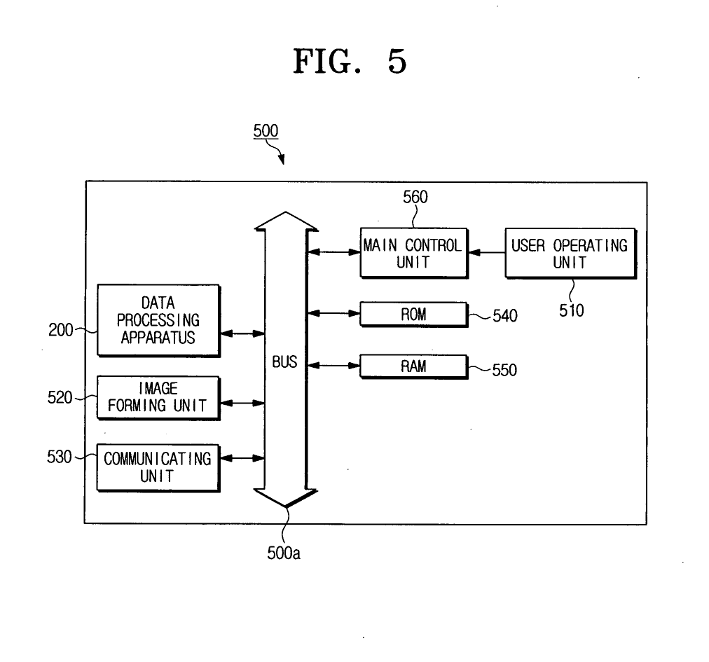

FIG. 5 is a block diagram illustrating an image forming apparatus 500 using the data processing apparatus of FIG. 2.

Referring to FIGS. 2 to 5, the data processing apparatus 200 using the soft keyboard is installed in the image forming apparatus 500.

The image forming apparatus 500 is an apparatus to form images on paper or transfer the images formed on the paper. The image forming apparatus 500 may include a printer having a printing function, a fax machine having a fax transmitting function, a copier having a copying function, a scanner having a scanning function, and a combination machine having printing, fax transmitting, copying and scanning functions.

The image forming apparatus 500 inputs, stores or edits long sentence data such as an e-mail by using the soft keyboard of the data processing apparatus 200, and transmits the input data to an external apparatus.

The image forming apparatus 500 includes a user operating unit 510, the data processing apparatus 200, an image forming unit 520, a communicating unit 530, a ROM 540, a RAM 550 and a main control unit 560. A bus 500a is a data transmission path between the blocks.

The user operating unit 510 is a user interface to output signals to operate functions supported by the image forming apparatus 500 to the main control unit 560. For this, the user operating unit 510 includes various function keys (not illustrated) to support input of characters, numbers and directions, and an e-mail button (not illustrated) relating to e-mail preparation and transmission.

As illustrated in FIG. 2, the data processing apparatus 200 includes a touch screen unit 210, a coordinate calculating unit 220, a data storing unit 230, a graphic control unit 240, a graphic storing unit 250, a ROM 260, a RAM 270 and a control unit 280. The data processing apparatus 200 is operated as described above, and thus detailed explanations thereof are omitted.

The image forming unit 520 generates image data on input paper, and performs an operation relating to the image data. For example, the image forming unit 520 performs the scanning, printing, copying and fax transmitting operations.

The communicating unit 530 performs data communication with an external image forming apparatus (not illustrated), a personal computer (not illustrated) and a server (not illustrated) connected through a network such as an Internet. For this, the communicating unit 530 includes a network interface card. For example, the communicating unit 530 transmits the e-mail prepared by using the data processing apparatus 200 to a correspondent apparatus.

The ROM 540 stores various control programs to execute the functions of the image forming apparatus 500, and a management program for data input/output with the data processing apparatus 200. The management program for data input/output is also stored in the data processing apparatus 200.

The RAM 550 stores various data generated during the operation of the image forming apparatus 500.

The main control unit 560 controls all of the operations of the image forming apparatus 500 according to the control programs stored in the ROM 540. When the e-mail button (not illustrated) of the user operating unit 510 is selected, the main control unit 560 requests the data processing apparatus 200 to display the user interface screen of FIG. 3A. The control unit 280 of the data processing apparatus 200 controls the graphic control unit 240 and the display unit 212 to display the user interface screen of FIG. 3A on the display unit 212.

After the e-mail is prepared and edited by the process described with reference to FIGS. 3A to 3D, the control unit 280 outputs the prepared e-mail data to the main control unit 560. The main control unit 560 controls the communicating unit 530 to transmit the e-mail data prepared by using the soft keyboard of the data processing apparatus 200 to a receiving-side e-mail address.

As described above, the data processing apparatus 200 using the soft keyboard of FIG. 2 is installed in the image forming apparatus 500, to enable the user to easily prepare and edit long sentence data such as an e-mail. Therefore, the image forming apparatus 500 can easily transmit the e-mail to the receiving side address. Besides the e-mail function, it can be applied to data edition for fax transmission. In accordance with the present general inventive concept, the data processing apparatus 200 can be applied to not only the image forming apparatus 500, but also to all electronic apparatuses using a touch screen mode, such as a computer, a PDA, a refrigerator and a cellular phone.

As discussed earlier, in accordance with the present general inventive concept, the data processing apparatus and method using the soft keyboard can selectively display long sentence data input by the touch screen mode on a special window. When the data which need to be edited are selected on the special window displaying the input data, the selected data and the adjacent data are displayed on an editable window. As a result, the user can easily edit the data.

Especially, when the data processing apparatus of the present general inventive concept is applied to the image forming apparatus having the e-mail transmitting function, the user may easily prepare an e-mail by using the data processing apparatus, review the prepared e-mail on the special window, select an error part or an editing part, correct the corresponding part, and transmit the corrected e-mail to a receiving side e-mail address.

The data processing apparatus is applicable to all electronic apparatuses using a touch screen mode.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains. The method illustrated in FIG. 4 can be stored in the computer-recorded medium in a form of computer-readable codes to perform the method when the computer reads the computer-readable codes of the recording medium.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A data processing apparatus using a soft keyboard, comprising:
a touch screen unit to display a first window on which a soft keyboard which inputs characters by a touch screen mode is displayed, and a second window on which the characters input through the soft keyboard are displayed; and
a control unit to control the touch screen unit to display a button to request whole screen display of the input characters, when the input characters exceed a set width of the second window.

2. The data processing apparatus as claimed in claim 1, further comprising:
a storing unit to store widths of the characters displayed on the soft keyboard and the width of the second window.

3. The data processing apparatus as claimed in claim 1, wherein, when the width of the second window is smaller than a total width of the characters displayed on the second window, the control unit controls the touch screen unit to display the button to request the whole screen display.

4. The data processing apparatus as claimed in claim 1, wherein, when the button to request the whole screen display is selected, a third window to display all of the input characters is displayed.

5. The data processing apparatus as claimed in claim 4, wherein, when the button to request the whole screen display is selected, the third window is displayed to overlap the first window on the soft keyboard.

6. The data processing apparatus as claimed in claim 4, wherein, when the character displayed on the third window is selected, the selected character is displayed on the second window.

7. The data processing apparatus as claimed in claim 6, wherein, after at least one character which needs to be edited is selected, the control unit removes the third window from display.

8. The data processing apparatus as claimed in claim 6, wherein the character is selected for deletion or revision.

9. A data processing method using a soft keyboard, comprising:
displaying a soft keyboard to input characters by a touch screen mode on a first window of a screen;
displaying the characters input through the soft keyboard on a second window of the screen; and
when the input characters exceed a set width of the second window, displaying a button to request whole screen display of the input characters.

10. The data processing method as claimed in claim 9, wherein widths of the characters displayed on the soft keyboard and the width of the second window are stored in a memory in advance.

11. The data processing method as claimed in claim 10, wherein the button is displayed when the width of the second window is smaller than a total width of the characters displayed on the second window.

12. The data processing method as claimed in claim 9, further comprising:
when the displayed button is selected, displaying a third window to display all of the input characters.

13. The data processing method as claimed in claim 12, wherein, the third window is displayed to overlap the first window on the soft keyboard.

14. The data processing method as claimed in claim 12, further comprising:
when the character displayed on the third window is selected, displaying the selected character on the second window.

15. The data processing method as claimed in claim 14, wherein, after the character is selected, the third window is removed from display.

16. The data processing method as claimed in claim 14, wherein the character is selected for deletion or revision.

17. A data processing apparatus, comprising:
a user interface to display a first window on which a soft keyboard which inputs characters by touch and a second window on which the characters input through the soft keyboard are displayed; and
a control unit to control the user interface to selectively display a third window based on the number of characters input through the soft keyboard.

18. The data processing apparatus of claim 17, wherein the control unit controls the user interface to display a whole screen button which requests the display of the third window when a predetermined number of characters are input through the soft keyboard.

19. The data processing apparatus of claim 18, wherein the control unit displays the whole screen button when a total width of the input characters exceeds a width of the second window.

20. The data processing apparatus of claim 18, wherein the control unit controls a number of characters displayed on the second window on a basis of a difference between a width of the whole screen button and a width of the second window.

21. The data processing apparatus of claim 17, wherein the user interface selects a character from the third window by user touch and the control unit controls the user interface to display the selected character at a designated position in the second window.

22. The data processing apparatus of claim 21, wherein the designated position is at a beginning or an end portion of the second window.

23. The data processing apparatus of claim 21, further comprising:
a data storing unit to store data relating to a character, image, or symbol displayed on the user interface;
a coordinate calculating unit to calculate coordinates of the selected character displayed on the third window; and
a graphic control unit to generate and display the selected character at the designated position of the second window based on the calculated coordinates.

24. The data processing apparatus of claim 17, wherein the user interface further comprises a display unit such as an LCD or CRT.

25. The data processing apparatus of claim 18, wherein the user interface further comprises a touch pad having an indium tin oxide (ITO) glass or ITO film

26. A computer-readable recording medium having embodied thereon a computer program to execute a data processing method using a soft keyboard, the method comprising:
displaying a soft keyboard to input characters by a touch screen mode on a first window of a screen;
displaying the characters input through the soft keyboard on a second window of the screen; and
when the input characters exceed a set width of the second window, displaying a button to request whole screen display of the input characters.

27. A method of displaying data on a user interface, the method comprising:
displaying a first window on which a soft keyboard to input characters by touch are displayed;
displaying a second window on which the characters input through the soft keyboard are displayed; and
controlling the user interface to selectively display the characters input through the soft keyboard in a third window overlapping the second window.

28. A computer-readable recording medium having embodied thereon a computer program to execute a method of displaying data on a user interface, the method comprising:
displaying a first window on which a soft keyboard to input characters by touch are displayed;
displaying a second window on which the characters input through the soft keyboard are displayed; and
controlling the user interface to selectively display the characters input through the soft keyboard in a third window overlapping the second window.
